(19) United States
(12) Patent Application Publication
(10) Pub. No.: US 2008/0207805 A1
(43) Pub. Date: Aug. 28, 2008

(54) INKJET INK SET FOR HIGH IMAGE QUALITY ON PHOTOGLOSSY PAPER AND PLAIN PAPER

(76) Inventors: James W. Blease, Avon, NY (US); Thomas B. Brust, Webster, NY (US); Hujuan D. Chen, Webster, NY (US); Gang C. Han-Adebekun, Center Valley, PA (US); Mark E. Irving, Rochester, NY (US); David T. Southby, Rochester, NY (US); David S. Uerz, Ontario, NY (US)

Correspondence Address: Andrew J. Anderson;Patent Legal Staff, Eastman Kodak Company, 343 State Street, Rochester, NY, 14650-2201, US

(21) Appl. No.: 12/029,986

(22) Filed: Feb. 12, 2008

Related U.S. Application Data
(60) Provisional application No. 60/892,176, filed on Feb. 28, 2007.

(51) Int. Cl. C09D 11/10; G01D 11/00

(52) U.S. Cl. 524/145; 524/1; 524/608; 524/556; 524/81; 524/379; 524/386; 347/100

(57) ABSTRACT

A water based inkjet ink set with excellent image stability, durability and quality, comprising at least one cyan ink, at least one magenta ink, at least one yellow ink, at least one black ink, and at least one colorless protective ink, wherein:
(a) the cyan, magenta, yellow, and black inks each comprise a pigment colorant;
(b) the cyan, magenta, yellow, black, and colorless protective inks each comprise a polymeric binder additive; and
(c) the surface tensions of the inks have the following relationships:
   (i) the dynamic surface tension at 10 milliseconds surface age for all inks of the ink set is greater than or equal to 35 mN/m,
   (ii) the static surface tensions of the yellow ink and of the colorless protective ink are at least 2.0 mN/m lower than the static surface tensions of the cyan, magenta and black inks of the ink set and
   (iii) the static surface tension of the colorless protective ink is at least 1.0 mN/m lower than the static surface tension of the yellow ink.

### CROSS REFERENCE TO RELATED APPLICATIONS

This 35 USC 111A application claims the benefit of Provisional Application Ser. No. 60/892,176 filed Feb. 28, 2007, the disclosure of which is incorporated by reference herein in its entirety.

Reference is also made to commonly assigned, co-pending application Ser. No. ______ (based on Provisional Application Ser. No. 60/892,158 filed Feb. 28, 2007 (Kodak Docket 93606)) and ______ (based on Provisional Application Ser. No. 60/892,171 filed Feb. 28, 2007 (Kodak Docket 93607)) by Brust et al., and application Ser. No. ______ (based on Provisional Application Ser. No. 60/892,137 filed Feb. 28, 2007 (Kodak Docket 93270)) by Han-Adebekun et. al., filed of even date herewith.

### FIELD OF THE INVENTION

The invention relates generally to the field of inks, and in particular to inks for inkjet printing. More specifically, the invention relates to colored inkjet inks having excellent image quality image on both photoglossy paper and plain paper.

### BACKGROUND OF THE INVENTION

Inkjet printing is a non-impact method for producing printed images by the deposition of ink droplets in a pixel-by-pixel manner to an image-recording element in response to digital data signals. There are various methods that may be utilized to control the deposition of ink droplets on the image-recording element to yield the desired printed image. In one process, known as drop-on-demand inkjet, individual ink droplets are projected as needed onto the image-recording element to form the desired printed image. Common methods of controlling the projection of ink droplets in drop-on-demand printing include piezoelectric transducers and thermal bubble formation. In another process, known as continuous inkjet, a continuous stream of droplets is charged and deflected in an image-wise manner onto the surface of the image-recording element, while un-imaged droplets are caught and returned to an ink sump. Inkjet printers have found broad applications across markets ranging from desktop document and photographic-quality imaging, to short run printing and industrial labeling.

The ink compositions known in the art of inkjet printing may be aqueous- or solvent-based, and in a liquid, solid or gel state at room temperature and pressure. Aqueous-based ink compositions are preferred because they are more environmentally friendly as compared to solvent-based inks, plus most printheads are designed for use with aqueous-based inks.

The ink composition may be colored with pigments, dyes, polymeric dyes, loaded-dye/latex particles, or any other types of colorants, or combinations thereof. Pigment-based ink compositions are used because such inks render printed images giving comparable optical densities with better resistance to light and ozone as compared to printed images made from other types of colorants. The colorant in the ink composition may be yellow, magenta, cyan, black, gray, red, violet, blue, green, orange, brown, etc.

Although numerous ink compositions are known in the art of inkjet printing, several key challenges remain. One challenge is to obtain the highest possible image quality on a variety of inkjet receivers. Typically the receivers are categorized as a photoglossy or plain paper receiver. The two types of receivers are distinguished from one another in that the photoglossy receiver is manufactured with a coated layer above the underlying paper support. Photoglossy receivers may be further categorized as having a swellable polymer coating (non-porous media) or a microporous (hydrophilic particles in binder) media, although hybrid designs are also well known. Typical polymer coated media are capable of very high gloss in excess of 60 gloss units at a viewing angle of 60 degrees. Typical microporous media can be designed to have gloss values approaching those of some polymer coated media. The design of the both plain paper and photoglossy media vary widely depending on materials and paper manufacturing processes which should not be construed to limit the scope of the present invention.

Due to the disparate nature of plain paper receivers and microporous photoglossy receivers, color-to-color ink bleed (also referred to as inter-color bleed) is an image quality characteristic that is particularly difficult to control on both types of inkjet receivers using a single inkjet ink set A high level of inter-color bleed is often noticeable in a printed image containing a distinct boundary between dark and light areas, for example between a yellow and black area. High inter-color bleed is easily observable at the light to dark boundary. The presence of bleed is often described as wicking or feathering, usually of the dark color into the light, thereby blurring the distinct boundary. Inter-color bleed can also be observed between darker color regions of an image for example between blue and red areas. An objectionable degradation in the image quality can result if the inter-color bleed is high enough. In addition the use of a colorless protective ink in an ink set for the purpose of improving image gloss and durability creates unique challenges to minimize bleed, that is color ink into colorless ink bleed.

A second challenge for inkjet printing is the stability and durability of the image created on the various types of inkjet receivers. It is generally known that inks employing pigments as ink colorants provide superior image stability relative to dye based inks for light fade and fade due to environmental pollutants especially when printed on microporous photoglossy receivers. For good physical durability (for example abrasion resistance) pigment based inks can be improved by addition of a binder polymer in the ink composition.

A further challenge for inks comprising both pigments and polymeric binders is managing the absorption behavior of pigment plus binder based ink compositions into microporous photoglossy receivers as well as plain paper receivers. It is desired that inks with pigment plus binder provide excellent image quality both on microporous photoglossy receivers and plain paper receivers. Use of a colorless protective ink adds yet a further requirement to manage its absorption behavior into microporous photoglossy receivers in a complementary manner with the pigment plus binder inks of the ink set to minimize inter-color bleed.

US2007/0022902A1 describes an inkjet ink set comprising dye based cyan, magenta and yellow inks and a pigment based black ink along with specific dynamic surface tension values for the inks in order to control inter-color bleed on ordinary plain paper receivers. Dye based inks, however, will have unacceptable fade performance on microporous photoglossy receivers. Further, optimization of dynamic and static surface tensions for pigment-based inks to control inter-color bleed on microporous photoglossy receivers is not given.

U.S. Pat. No. 7,037,362 B2 provides an example of a dye based ink with dynamic surface tension values of greater than 45 mN/m at 10 milliseconds surface age and greater than 35 mN/m at 1000 milliseconds. Only plain paper receiver is used to test the ink compositions and no guidance is provided on how best to balance the surface tensions among a set of inks including a set containing a colorless protective ink to provide low inter-color bleed on microporous photoglossy receivers. In addition, the dye based inks will have unacceptable fade performance on microporous photoglossy receivers. Further, optimization of dynamic and static surface tensions for pigment-based inks to control inter-color bleed on microporous photoglossy receivers is not given.

U.S. Pat. No. 6,536,891 B2 describes an inkjet ink set comprising pigment based cyan, magenta, yellow and black inks with a specific static surface tension order. The black ink static surface tension exceeds the cyan and magenta ink static surface tensions. The yellow ink static surface tensions falls below the cyan and magenta ink static surface tensions. Only plain paper inkjet receivers were used to evaluate inter-color bleed of the ink set. Further, optimization of dynamic and static surface tensions for pigment-based inks to control inter-color bleed on microporous photoglossy receivers is not given, in particular for ink sets used in combination with a colorless protective ink.

US2004/0069183A1 describes an inkjet ink set comprising pigment based cyan, magenta, yellow and black inks wherein each ink of the set conforms to a requirement of less than 7 mN/m difference between the static and dynamic surface tension. It also states that both static and dynamic surface tensions are necessary to represent the properties of an inkjet ink. However no distinction is made between the inks of the ink set regarding dynamic or static surface tension to minimize inter-color bleed on both microporous photoglossy receivers and plain paper receivers. In particular, the example inks provided give a lower value for the static and dynamic surface tension of the cyan ink of the ink set relative to the yellow and magenta inks. The ink set also shows the static surface tension of the black ink to be higher than the yellow ink.

US2006/0103691A1 describes a six ink set consisting of pigment based cyan, magenta, yellow, first black and second black inks and a colorless protective ink. However, no description is provided of the preferred static and dynamic surface tensions for the ink of the ink set.

### PROBLEM TO BE SOLVED BY THE INVENTION

In order to achieve low inter-color bleed on both types of receivers and to allow use of a colorless protective ink for optimum image characteristics on microporous photoglossy receivers, it has been discovered that ink specific dynamic and static surface tension settings are necessary for the pigment based inks and colorless protective ink of an ink set. The ink set ink of the present invention provides excellent image stability and durability owing to the use of pigment inks containing polymeric binders in combination with a colorless protective ink. As well, the inventive ink set gives very low inter-color bleed on both microporous photoglossy receivers and plain paper receivers when printed through an inkjet printer.

### SUMMARY OF THE INVENTION

The present invention is directed to overcoming one or more of the problems set forth above. In one embodiment, the invention is directed towards a water based inkjet ink set comprising at least one cyan ink, at least one magenta ink, at least one yellow ink, at least one black ink, and at least one colorless protective ink, wherein:

(a) the cyan, magenta, yellow, and black inks each comprise a pigment colorant;

(b) the cyan, magenta, yellow, black, and colorless protective inks each comprise a polymeric binder additive; and

(c) the surface tensions of the inks have the following relationships:
(i) the dynamic surface tension at 10 milliseconds surface age for all inks of the ink set is greater than or equal to 35 mN/m,
(ii) the static surface tensions of the yellow ink and of the colorless protective ink are at least 2.0 mN/m lower than the static surface tensions of the cyan, magenta and black inks of the ink set, and
(iii) the static surface tension of the colorless protective ink is at least 1.0 mN/m lower than the static surface tension of the yellow ink.
   In a further embodiment, the invention also provides an inkjet printing method comprising the steps of a) providing an inkjet printer that is responsive to digital data signals; b) loading the printer with an inkjet recording receiver; c) loading the printer with the inkjet ink set of the invention; and d) printing on the inkjet receiver with the ink set of the invention in response to the digital data signals.

The inkjet ink set of the present invention has the following advantages: provides very good printed image stability on microporous photoglossy inkjet receivers and plain paper receivers; provides very good physical durability on microporous photoglossy inkjet receivers and plain paper receivers; and provides very low inter-color bleed on microporous photoglossy inkjet receivers and plain paper receivers.

### DETAILED DESCRIPTION OF THE INVENTION

Ink compositions of the present invention are aqueous-based. By aqueous-based, it is meant that the majority of the liquid components in the ink composition are water, preferably greater than 50% water and more preferably greater than 60% water.

The water compositions useful in the invention may also include humectants and/or co-solvents in order to prevent the ink composition from drying out or crusting in the nozzles of the printhead, aid solubility of the components in the ink composition, or facilitate penetration of the ink composition into the image-recording element after printing. Representative examples of humectants and co-solvents used in aqueous-based ink compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) polyhydric alcohols, such as ethylene glycol, diethylene glycol, triethylene glycol, tetraethylene glycol, propylene glycol, polyethylene glycol, polypropylene glycol, 1,2-propane diol, 1,3-propane diol, 1,2-butane diol, 1,3-butane diol, 1,4-butane diol, 1,2-pentane diol, 1,5-pentanediol, 1,2-hexanediol, 1,6-hexane diol, 2-methyl-2,4-pentanediol, 1,2-heptane diol, 1,7-hexane diol, 2-ethyl-1,3-hexane diol, 1,2-octane diol, 2,2,4-trimethyl-1,3-pentane diol, 1,8-octane diol, glycerol, 1,2,6-hexanetriol, 2-ethyl-2-hydroxymethyl-propane diol, saccharides and sugar alcohols and thioglycol; (3) lower mono- and di-alkyl ethers derived from the polyhydric alcohols; such as, ethylene glycol monomethyl ether, ethylene glycol monobutyl ether, ethylene glycol monoethyl ether acetate, diethylene glycol monomethyl ether, and diethylene glycol monobutyl ether acetate (4) nitrogen-containing compounds such as urea, 2-pyrrolidone, N-methyl-2-pyrrolidone, and 1,3-dimethyl-2-imidazolidinone; and (5) sulfur-containing compounds such as 2,2′-thiodiethanol, dimethyl sulfoxide and ethylene sulfone.

The ink compositions of the invention are pigment-based because such inks render printed images having higher optical densities and better resistance to light and ozone as compared to printed images made from other types of colorants. Pigments that may be used in the invention include those disclosed in, for example, U.S. Pat. Nos. 5,026,427; 5,086,698; 5,141,556; 5,160,370; and 5,169,436. The exact choice of pigments will depend upon the specific application and performance requirements such as color reproduction and image stability.

Pigments suitable for use in the invention include, but are not limited to, azo pigments, monoazo pigments, disazo pigments, azo pigment lakes, β-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black.

Typical examples of pigments that may be used include Color Index (C.I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66, bridged aluminum phthalocyanine pigments; C.I. Pigment Black 1, 7, 20, 31, 32; C. I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C.I. Pigment Green 1, 2, 4, 7, 8, 10, 36, 45; C.I. Pigment Violet 1, 2, 3, 5:1, 13, 19, 23, 25, 27, 29, 31, 32, 37, 39, 42, 44, 50, and mixtures thereof.

Self-dispersing pigments that are dispersible without the use of a dispersant or surfactant may also be useful in the invention. Pigments of this type are those that have been subjected to a surface treatment such as oxidation/reduction, acid/base treatment, or functionalization through coupling chemistry, such that a separate dispersant is not necessary. The surface treatment can render the surface of the pigment with anionic, cationic or non-ionic groups. See for example, U.S. Pat. No. 6,494,943 B1 and U.S. Pat. No. 5,837,045. Examples of self-dispersing type pigments include Cab-O-Jet 200® and Cab-O-Jet 300® (Cabot Specialty Chemicals, Inc.) and Bonjet CW-1®, CW-2® and CW-3® (Orient Chemical Industries, Ltd.). In particular, a self-dispersing carbon black pigment ink may be employed in the ink set of the invention, wherein ink comprises a water soluble polymer containing acid groups neutralized by an inorganic base, and the carbon black pigment comprises greater than 11 weight % volatile surface functional groups as disclosed in commonly assigned, copending U.S. Ser. No. ______ (based on Provisional Application Ser. No. 60/892,137 filed Feb. 28, 2007 (Kodak Docket 93270)), the disclosure of which is incorporated by reference herein.

Pigment-based ink compositions useful in the invention may be prepared by any method known in the art of inkjet printing. Useful methods commonly involve two steps: (a) a dispersing or milling step to break up the pigments to primary particles, where primary particle is defined as the smallest identifiable subdivision in a particulate system, and (b) a dilution step in which the pigment dispersion from step (a) is diluted with the remaining ink components to give a working strength ink.

The milling step (a) is carried out using any type of grinding mill such as a media mill, a ball mill, a two-roll mill, a three-roll mill, a bead mill, and air-jet mill, an attritor, or a liquid interaction chamber. In the milling step (a), pigments are optionally suspended in a medium which is typically the same as or similar to the medium used to dilute the pigment dispersion in step (b). Inert milling media are optionally present in the milling step (a) in order to facilitate break up of the pigments to primary particles. Inert milling media include such materials as polymeric beads, glasses, ceramics, metals and plastics as described, for example, in U.S. Pat. No. 5,891,231. Milling media are removed from either the pigment dispersion obtained in step (a) or from the ink composition obtained in step (b).

A dispersant is optionally present in the milling step (a) in order to facilitate break up of the pigments into primary particles. For the pigment dispersion obtained in step (a) or the ink composition obtained in step (b), a dispersant is optionally present in order to maintain particle stability and prevent settling. Dispersants suitable for use in the invention include, but are not limited to, those commonly used in the art of inkjet printing. For aqueous pigment-based ink compositions, useful dispersants include anionic, cationic or nonionic surfactants such as sodium dodecylsulfate, or potassium or sodium oleylmethyltaurate as described in, for example, U.S. Pat. No. 5,679,138; U.S. Pat. No. 5,651,813 or U.S. Pat. No. 5,985,017.

Polymeric dispersants are also known and useful in aqueous pigment-based ink compositions. Polymeric dispersants may be added to the pigment dispersion prior to, or during the milling step (a), and include polymers such as homopolymers and copolymers; anionic, cationic or nonionic polymers; or random, block, branched or graft polymers. Polymeric dispersants useful in the milling operation include random and block copolymers having hydrophilic and hydrophobic portions; see for example, U.S. Pat. No. 4,597,794; U.S. Pat. No. 5,085,698; U.S. Pat. No. 5,519,085; U.S. Pat. Nos. 5,272,201; 5,172,133; or U.S. Pat. No. 6,043,297; and graft copolymers; see for example, U.S. Pat. No. 5,231,131; U.S. Pat. No. 6,087,416; U.S. Pat. No. 5,719,204; or U.S. Pat. No. 5,714,538.

Composite colorant particles having a colorant phase and a polymer phase are also useful in aqueous pigment-based inks of the invention. Composite colorant particles are formed by polymerizing monomers in the presence of pigments; see for example, U.S. 2003/0199614, U.S. 2003/0203988, or U.S. 2004/0127639. Microencapsulated-type pigment particles are also useful and consist of pigment particles coated with a resin film; see for example U.S. Pat. No. 6,074,467.

The pigments used in the ink composition of the invention maybe present in any effective amount, generally from 0.1 to 10% by weight, and preferably from 0.5 to 6% by weight.

Inkjet ink compositions may also contain non-colored particles such as inorganic particles or polymeric particles. The use of such particulate addenda has increased over the past several years, especially in inkjet ink compositions intended for photographic-quality imaging. For example, U.S. Pat. No. 5,925,178 describes the use of inorganic particles in pigment-based inks in order to improve optical density and rub resistance of the pigment particles on the image-recording element. In another example, U.S. Pat. No. 6,508,548 B2 describes the use of a water-dispersible polymeric latex in dye-based inks in order to improve light and ozone resistance of the printed images.

The ink composition may contain non-colored particles such as inorganic or polymeric particles in order to improve gloss differential, light and/or ozone resistance, waterfastness, rub resistance and various other properties of a printed image; see for example, U.S. Pat. No. 6,598,967 B1 or U.S. Pat. No. 6,508,548 B2. Colorless ink compositions that contain non-colored particles and no colorant may also be used For example US2006/0100307A1 describes an inkjet ink comprising an aqueous medium and microgel particles. Colorless ink compositions are often used in the art as “fixers” or insolubilizing fluids that are printed under, over, or with colored ink compositions in order to reduce bleed between colors and waterfastness on plain paper; see for example, U.S. Pat. No. 5,866,638 or U.S. Pat. No. 6,450,632 B1. Colorless inks are also used to provide an overcoat to a printed image, usually in order to improve scratch resistance and waterfastness; see for example, U.S. 2003/0009547 A1 or E.P. 1,022,151 A1. Colorless inks are also used to reduce gloss differential in a printed image; see for example, U.S. Pat. No. 6,604,819 B2; U.S. 2003/0085974 A1; U.S. 2003/0193553 A1; or U.S. 2003/0189626 A1.

Examples of inorganic particles useful in the invention include, but are not limited to, alumina, boehmite, clay, calcium carbonate, titanium dioxide, calcined clay, aluminosilicates, silica, or barium sulfate.

For aqueous-based inks, polymeric binders useful in the invention include water-dispersible polymers generally classified as either addition polymers or condensation polymers, both of which are well-known to those skilled in the art of polymer chemistry. Examples of polymer classes include acrylics, styrenics, polyethylenes, polypropylenes, polyesters, polyamides, polyurethanes, polyureas, polyethers, polycarbonates, polyacid anhydrides, and copolymers consisting of combinations thereof Such polymer particles can be ionomeric, film-forming, non-film-forming, fusible, or heavily cross-linked and can have a wide range of molecular weights and glass transition temperatures.

Examples of useful polymeric binders include styrene-acrylic copolymers sold under the trade names Joncryl® (S.C. Johnson Co.), Ucar™ (Dow Chemical Co.), Jonrez® (MeadWestvaco Corp.), and Vancryl® (Air Products and Chemicals, Inc.); sulfonated polyesters sold under the trade name Eastman AQ® (Eastman Chemical Co.); polyethylene or polypropylene resin emulsions and polyurethanes (such as the Witcobonds® from Witco). These polymers are preferred because they are compatible in typical aqueous-based ink compositions, and because they render printed images that are highly durable towards physical abrasion, light and ozone.

The non-colored particles and binders useful in the ink composition of the invention may be present in any effective amount, generally from 0.01 to 20% by weight, and preferably from 0.01 to 6% by weight. The exact choice of materials will depend upon the specific application and performance requirements of the printed image.

Ink compositions may also contain water-soluble polymer binders. The water-soluble polymers useful in the ink composition are differentiated from polymer particles in that they are soluble in the water phase or combined water/water-soluble solvent phase of the ink. The term “water-soluble” is meant herein that when the polymer is dissolved in water and when the polymer is at least partially neutralized the resultant solution is visually clear. Included in this class of polymers are nonionic, anionic, amphoteric and cationic polymers. Representative examples of water soluble polymers include, polyvinyl alcohols, polyvinyl acetates, polyvinyl pyrrolidones, carboxy methyl cellulose, polyethyloxazolines, polyethyleneimines, polyamides and alkali soluble resins; polyurethanes (such as those found in U.S. Pat. No. 6,268,101), polyacrylic type polymers such as polyacrylic acid and styrene-acrylic methacrylic acid copolymers (such as; as Joncryl® 70 from S.C. Johnson Co., TruDot™ IJ-4655 from MeadWestvaco Corp., and Vancryl® 68S from Air Products and Chemicals, Inc.

Examples of water-soluble acrylic type polymeric additives and water dispersible polycarbonate-type or polyether-type polyurethanes which may be used in the inks of the ink sets of the invention are described in copending, commonly assigned U.S. Ser. Nos. ______ and ______ (based on Provisional Application Ser. Nos. 60/892,158 and 60/892,171 filed Feb. 28, 2007 (Kodak Dockets 93606 and 93607)), the disclosures of which are incorporated by reference herein. Polymeric binder additives useful in the inks of the ink set of the invention are also described in for example US 2006/0100307A1 and US2006/0100308A1.

In accordance with the invention, ink static and dynamic surface tensions are controlled so that inks of an ink set can provide prints with the desired inter-color bleed. In particular, it has been found that the dynamic surface tension at 10 milliseconds surface age for all inks of the ink set comprising cyan, magenta, yellow, and black pigment-based inks and a colorless protective ink should be greater than or equal to 35 mN/m, while the static surface tensions of the yellow ink and of the colorless protective ink should be at least 2.0 mN/m lower than the static surface tensions of the cyan, magenta and black inks of the ink set, and the static surface tension of the colorless protective ink should be at least 1.0 mN/m lower than the static surface tension of the yellow ink, in order to provide acceptable performance for inter-color bleed on both microporous photoglossy and plain paper. In preferred embodiments, the static surface tension of the yellow ink is at least 2.0 mN/m lower than all other inks of the ink set excluding the clear protective ink, and the static surface tension of the clear protective ink is at least 2.0 mN/m lower than all other inks of the ink set excluding the yellow ink.

Surfactants maybe added to adjust the surface tension of the inks to appropriate levels. The surfactants may be anionic, cationic, amphoteric or nonionic and used at levels of 0.01 to 5% of the ink composition. Examples of suitable nonionic surfactants include, linear or secondary alcohol ethoxylates (such as the Tergitol® 15-S and Tergitol® TMN series available from Union Carbide and the Brij® series from Uniquema), ethoxylated alkyl phenols (such as the Triton® series from Union Carbide), fluoro surfactants (such as the Zonyls® from DuPont; and the Fluorads® from 3M), fatty acid ethoxylates, fatty amide ethoxylates, ethoxylated and propoxylated block copolymers (such as the Pluronic® and Tetronic® series from BASF, ethoxylated and propoxylated silicone based surfactants (such as the Silwet® series from CK Witco) , alkyl polyglycosides (such as the Glucopons® from Cognis) and acetylenic polyethylene oxide surfactants (such as the Surfynols from Air Products).

Examples of anionic surfactants include; carboxylated (such as ether carboxylates and sulfosuccinates), sulfated (such as sodium dodecyl sulfate), sulfonated (such as dodecyl benzene sulfonate, alpha olefin sulfonates, alkyl diphenyl oxide disulfonates, fatty acid taurates and alkyl naphthalene sulfonates), phosphated (such as phosphated esters of alkyl and aryl alcohols, including the Strodex® series from Dexter Chemical), phosphonated and amine oxide surfactants and anionic fluorinated surfactants. Examples of amphoteric surfactants include; betaines, sultaines, and aminopropionates. Examples of cationic surfactants include; quaternary ammonium compounds, cationic amine oxides, ethoxylated fatty amines and imidazoline surfactants. Additional examples are of the above surfactants are described in “McCutcheon's Emulsifiers and Detergents: 2003, North American Edition”.

A biocide may be added to an inkjet ink composition to suppress the growth of micro-organisms such as molds, fungi, etc. in aqueous inks. A preferred biocide for an ink composition is Proxel® GXL (Zeneca Specialties Co.) at a final concentration of 0.0001-0.5 wt. %. Additional additives which may optionally be present in an inkjet ink composition include thickeners, conductivity enhancing agents, anti-kogation agents, drying agents, waterfast agents, dye solubilizers, chelating agents, binders, light stabilizers, viscosifiers, buffering agents, anti-mold agents, anti-curl agents, stabilizers and defoamers.

The pH of the aqueous ink compositions of the invention may be adjusted by the addition of organic or inorganic acids or bases. Useful inks may have a preferred pH of from about 2 to 10, depending upon the type of dye or pigment being used. Typical inorganic acids include hydrochloric, phosphoric and sulfuric acids. Typical organic acids include methanesulfonic, acetic and lactic acids. Typical inorganic bases include alkali metal hydroxides and carbonates. Typical organic bases include ammonia, triethanolamine and tetramethylethlenediamine.

The exact choice of ink components will depend upon the specific application and performance requirements of the printhead from which they are jetted. Thermal and piezoelectric drop-on-demand printheads and continuous printheads each require ink compositions with a different set of physical properties in order to achieve reliable and accurate jetting of the ink, as is well known in the art of inkjet printing. Acceptable viscosities are no greater than 20 cP, and preferably in the range of about 1.0 to 6.0 cP.

For color inkjet printing, a minimum of cyan, magenta and yellow inks are required for an jet ink set which is intended to function as a subtractive color system. Very often black ink is added to the ink set to decrease the ink required to render dark areas in an image and for printing of black and white documents such as text. The need to print on both microporous photoglossy and plain paper receivers can make desirable a plurality of black inks in an ink set. In this case, one of the black inks may be better suited to printing on microporous photoglossy receivers while another black ink may be better suited to printing on plain paper. Use of separate black ink formulations for this purpose can be justified based on desired print densities, printed gloss, and smudge resistance for the type of receiver.

Other inks can be added to the ink set. These inks include light or dilute cyan, light or dilute magenta, light or dilute black, red, blue, green, orange, gray, and the like. Additional inks can be beneficial for image quality but they add system complexity and cost. Finally, colorless ink composition can be added to the inkjet ink set for the purpose of providing gloss uniformity, durability and stain resistance to areas in the printed image which receive little or no ink otherwise. Even for image areas printed with a significant level of colorant containing inks, the colorless ink composition can be added to those areas with further benefits. An example of a protective ink for the above purposes is described in US2006/0100306A1 and US2006/0100308A1.

As described above, in accordance with the invention, ink static and dynamic surface tensions are controlled so that inks of an ink set can provide prints with the desired inter-color bleed. Ink surface tensions in accordance with the invention are determined according to the following methods.

Static Surface Tension Measurement: The Wilhelmy plate method is a well known technique for measuring the static surface tension of a liquid at a solid interface. The technique involves a plate of known dimensions, typically selected from a roughened platinum alloy, suspended from a balance. The plate is contacted with a solution of interest and a vertical force is applied to the plate to form a liquid meniscus between the solution and plate. The resulting surface tension is given according to:

σ=F/L cos(θ)

where,

σ is the surface tension of the liquid

F is the force acting on the balance (milli-Newtons/meter)

L is the wetted length of the plate in millimeters

θ is the contact angle between the plate and solution

Typically, the roughened platinum results in a contact angle very close to zero and the cosine of θ goes to 1. A complete theoretical treatment of the method can be found in, for example, “A Method for Determining Surface and Interfacial Tension Using a Wilhelmy Plate”, Colloid and Polymer Science, 255(7), pages 675-681. A number of commercially available instruments are known for measuring surface tension, however, the instrument used to report surface tension values in the present invention is a Kruss Model K10ST tensiometer.

Dynamic Surface Tension Measurement: Dynamic surface tension is a well known property and there are several techniques are known for measuring dynamic surface tension. The technique used to measure dynamic surface tension of the inventive ink sets herein is called the maximum bubble pressure method. The technique is described in detail in several publications including, “The Measurement of Dynamic Surface Tension by the Maximum Bubble Pressure Method”, Colloid and Polymer Science, vol. 272, pages 731-739, 1994.

The operating principle behind the maximum bubble pressure method involves a stream of air being directed through a narrow circular cylindrical capillary where the capillary is submersed into the solution of interest, here an inkjet ink. The air stream forms an air bubble as it exits the capillary and is forced into the ink solution. The surface tension of the ink is determined by use of equation (1):

ΔP=P_{b}−Pₛ=2 σ/R (1)

where P_{b} is the pressure inside the air bubble, Pₛ is the pressure in the surrounding solution, σ is the surface tension of the ink and R is the radius of the air bubble. At the point where the radius of the bubble, R is equal to the radius of the capillary, r, the pressure in the bubble will be at it's maximum and equation (1) can be written as (2):

σ=ΔPₘr/2 (2)

where ΔPₘ is the maximum difference in pressure between the inside and outside of the bubble. Beyond this maximum pressure the bubble will detach from the capillary and the process will begin again. The process of bubble formation may be controlled such that the frequency of bubble formation is changed from very a rapid frequency to a relatively slow frequency. This rate of bubble formation is related to the surface age lifetime of the air bubble in the solution. For example, the bubble frequency may be changed so that surface lifetimes from about 10 milliseconds to about 50,000 milliseconds are achieved. As a result, a plot of dynamic surface tension versus time (age of surface life) can be generated. A number of commercially available instruments are known for measuring surface tension, however, the instrument used to report dynamic surface tension values in the present invention is a Kruss BP-2 bubble tensiometer.

In order to prepare the pigment based inks of the inventive ink set and the comparative inks, pigment dispersions for each color ink were first made according to the descriptions given below.

### Cyan Pigment Dispersion:

A mixture of Pigment Blue 15:3, potassium salt of oleylmethyl taurate (KOMT) and deionized water were charged into a mixing vessel along with polymeric beads having mean diameter of 50 μm, such that the concentration of pigment was 20% and KOMT was 25% by weight based on pigment. The mixture was milled with a dispersing blade for over 20 hours and allowed to stand to remove air. Milling media were removed by filtration and the resulting pigment dispersion was diluted to approximately 10% pigment with deionized water to obtain the cyan pigment dispersion.

### Magenta Pigment Dispersion:

The process used for cyan pigment dispersion was used except Pigment Red 122 was used in place of Pigment Blue 15:3 and the KOMT level was set at 30% by weight based on the pigment.

### Yellow Pigment Dispersion:

The process used for cyan pigment dispersion was used except Pigment Yellow 155 was used in place of Pigment Blue 15:3.

### First Black Pigment Dispersion:

The process used for cyan pigment dispersion was used except Pigment Black 7 was used in place of Pigment Blue 15:3.

In addition to the pigment dispersions, polymeric binder components are added to the inks to provide desirable attributes such as image durability and gloss uniformity. Specific polymeric additives and polymeric beads added to the inks in the below examples were:

Acrylic Polymer: benzylmethacrylate/methacrylic acid copolymer having an acid number of about 135 as determined by titration method, a weight average molecular weight of about 7160 and number average molecular weight of 4320 as determined by the Size Exclusion Chromatography. The polymer is neutralized with potassium hydroxide to have a degree of neutralization of about 85%.

Polyurethane Binder: polycarbonate-type polyurethane having a 76 acid number with a weight average molecular weight of 26,100 made with isophorone diisocyanate and a combination of poly(hexamethylene carbonate) diol and 2,2-bis(hydroxymethyl)proprionic acid where 100% of the acid groups are neutralized with potassium hydroxide.

Microgel particles: aqueous suspension of methyl methacrylate/divinyl benzene/methacrylic acid particles having fiftieth percentile particle size of 79 nm.

The inks of the inventive ink set and comparative inks were prepared by simple admixture of the components with stirring for at least one hour followed by 1.2 micron filtration. Table 1 provides weight percents of each component in the ink of the inventive ink set. Table 2 provides weight percents of each component in the comparative inks. All of the pigments are added as dispersions prepared according to the description above except the Orient CW-3 carbon black pigment dispersion was used as supplied. The amount of dispersion added to the ink was adjusted to provide the weight percent of pigment shown in tables 1 and 2. The amount of acrylic polymer additive, polyurethane binder additive and microgel suspension were also adjusted to provide the weight percent of polymer or microgel particles shown in tables 1 and 2. The following examples are provided to illustrate, but not to limit, the invention.

TABLE 1

| | Example Ink Set | | | | | |
|---|---|---|---|---|---|---|
| component | C-1 | M-1 | Y-1 | Bk1-1 | P-1 | Bk2-1 |
| pigment blue 15:3 | 2.20 | | | | | |
| pigment red 122 | | 3.00 | | | | |
| pigment yellow 155 | | | 2.75 | | | |
| pigment black 7, PB15:3, | | | | 2.50* | | |
| PR122 | | | | | | |
| Orient CW-3 pigment | | | | | | 4.50 |
| (self-dispersed carbon | | | | | | |
| black) | | | | | | |
| acrylic polymer | 0.90 | 0.90 | 1.50 | 0.90 | 0.80 | 0.40 |
| polyurethane binder | 1.20 | 1.20 | 1.60 | 1.20 | 2.40 | |
| microgel particles | | | | | 0.20 | |
| glycerol | 7.50 | 8.00 | 10.0 | 8.00 | 12.0 | 3.00 |
| ethylene glycol | 4.50 | 5.00 | 2.00 | 4.00 | 6.00 | |
| diethylene glycol | | | | | | 9.00 |
| polyethylene glycol | | | | | | 3.00 |
| 400 MW | | | | | | |
| Strodex PK-90 (anionic | | | | 0.41 | | |
| phosphate ester | | | | | | |
| surfactant) | | | | | | |
| Surfynol 465 (acetylenic | 0.75 | 0.50 | | | | |
| non-ionic surfactant) | | | | | | |
| Tergitol 15-S-5 (low | | | 0.75 | | 1.00 | |
| HLB secondary alcohol | | | | | | |
| ethoxylate non- | | | | | | |
| ionic surfactant) | | | | | | |
| Tergitol 15-S-12 | | | | | | 0.40 |
| (mid HLB secondary | | | | | | |
| alcohol ethoxylate non- | | | | | | |
| ionic surfactant) | | | | | | |
| Kordek MLX biocide | 0.02 | 0.02 | 0.02 | 0.02 | 0.02 | 0.02 |
| triethanolamine | 0.05 | 0.05 | | 0.05 | | |
| water | bal. | bal. | bal. | bal. | bal. | bal. |
| static surface tension | 35.8 | 36.2 | 31.4 | 33.8 | 30.2 | 34.0 |
| mN/m | | | | | | |
| dynamic surf. | 40.7 | 44.1 | 47.7 | 46.9 | 43.6 | 52.8 |
| ten. @ 10 ms. | | | | | | |

*1.625% PB7, 0.375% PB15:3, 0.50% PR122

TABLE 2

| component | C-2 | M-2 | Y-2 | Bk1-2 | P-2 | Y-3 | P-3 |
|---|---|---|---|---|---|---|---|
| pigment blue 15:3 | 2.20 | | | | | | |
| pigment red 122 | | 3.00 | | | | | |
| pigment yellow 155 | | | 2.75 | | | 2.75 | |
| pigment black 7, | | | | 2.50* | | | |
| PB15:3, PR122 | | | | | | | |
| acrylic polymer | 0.90 | 0.90 | 1.50 | 0.90 | 0.80 | 1.50 | 0.80 |
| polyurethane | 1.20 | 1.20 | 1.60 | 1.20 | 2.40 | 1.60 | 2.40 |
| binder | | | | | | | |
| microgel particles | | | | | 0.20 | | 0.20 |
| glycerol | 7.50 | 8.00 | 10.00 | 8.00 | 12.00 | 10.00 | 12.00 |
| ethylene glycol | 4.50 | 5.00 | 2.00 | 4.00 | 6.00 | 2.00 | 6.00 |
| diethylene glycol | | | | | | | |
| polyethylene | | | | | | | |
| glycol 400 MW | | | | | | | |
| Strodex PK-90 | 0.90 | 0.90 | 0.90 | 0.90 | 0.90 | | |
| Surfynol 465 | | | | | | 0.50 | 0.50 |
| Tergitol 15-S-5 | | | | | | | |
| Tergitol 15-S-12 | | | | | | | |
| Kordek MLX | 0.02 | 0.02 | 0.02 | 0.02 | 0.02 | 0.02 | 0.02 |
| biocide | | | | | | | |
| triethanolamine | 0.05 | 0.05 | | 0.05 | | | |
| water | bal. | bal. | bal. | bal. | bal. | bal. | bal. |
| static surface | 31.2 | 32.6 | 31.9 | 31.4 | 28.0 | 37.5 | 37.1 |
| tension mN/m | | | | | | | |
| dynamic surf. | 39.2 | 41.8 | 39.4 | 40.7 | 34.6 | | |
| ten. @ 10 ms. | | | | | | | |

*1.625% PB7, 0.375% PB15:3, 0.50% PR122

The static and dynamic surface tension values reported in tables 1 and 2 were measured at approximately 25° C.

In order to demonstrate the inter-color bleed advantages of the inventive ink set, the following ink sets were assembled:

Ink set 1: inks C-1, M-1, Y-1, Bk1-1, Bk2-1, P-1 (inventive ink set)

Ink set 2: inks C-2, M-2, Y-2, Bk1-2, Bk2-1, P-2 (comparative ink set)

Ink set 3: inks C-2, M-2, Y-3, Bk1-2, Bk2-1, P-3 (comparative ink set)

The cyan, magenta, yellow, first black, and colorless protective inks from each set were placed in the appropriate chamber of a Kodak No. 10 five chamber color ink cartridge. The second black ink was placed in a Kodak No. 10 single chamber black ink cartridge. Each cartridge was then mounted in a Kodak model 5100 thermal inkjet printer followed by a standard ink priming step to bring ink from the cartridge through the print head ink flow channels. Printing was done using printing modes optimized for ink set 1 when printed on Kodak microporous photoglossy receiver or Kodak Ultra plain paper inkjet receiver as appropriate for the receiver being used.

Inter-color bleed was evaluated by printing a multi-color checkerboard pattern and a 0.5 millimeter color line on a color background pattern that created all combinations of boundaries between areas of single color inks (cyan, magenta, yellow and black) and secondary colors of red (magenta and yellow), green (cyan and yellow) and blue (magenta and cyan). On the microporous photoglossy receiver areas not printed with a color ink were printed with colorless protective ink. On the plain paper receiver the colorless protective ink was not used. In addition on the plain paper receiver the first black ink of the ink sets was replaced by the second black ink of the ink sets to create black areas. The porous photoglossy receiver used was Kodak Ultra Premium Photo Paper—High Gloss, the plain paper receiver used was Kodak Premium Bright White Paper, 24 lb., 97 TAPPI brightness.

Once the three inks sets were printed on the microporous photoglossy receiver and plain paper receiver, the prints were manually evaluated by inspecting each print with a 7× loupe. The ratings are described as follows:
A—Good quality—little or no bleed observable even with the 7× loupe.
B—Fair quality—small fingers or intrusions from one color to the next observable with the loupe.
C—Poor quality—major intrusions and line-width narrowing observable with the naked eye.
D—Very poor quality—strong intermixing reaching several millimeters past the color-to-color boundaries in the image with lines and adjacent spaces completely filled with mixed colors.
   Inter-color bleed ratings C and D are considered unsatisfactory for printed image quality.

Table 3 summarizes the results for ink set A, the inventive ink set, and sets B and C, comparative ink sets respectively on the Kodak microporous photoglossy receiver and Kodak plain paper receiver.

TABLE 3

| | Kodak | | | | | |
|---|---|---|---|---|---|---|
| | Kodak Ultra | | | Kodak | | |
| | Premium Photo | | | Premium Bright | | |
| | Paper - High Gloss | | | White Paper | | |
| | | Ink | Ink | | Ink | Ink |
| color boundary | Ink Set 1 | Set 2 | Set 3 | Ink Set 1 | Set 2 | Set 3 |
| cyan-magenta | A | A | A | A | B | B |
| cyan-yellow | B | B | C | A | C | D |
| cyan-black 1 | A | A | A | A | A | A |
| cyan-red | A | B | B | B | C | D |
| cyan-green | A | A | A | A | A | A |
| cyan-blue | A | A | A | B | A | A |
| cyan-colorless | A | A | B | N/A | N/A | N/A |
| cyan-plain paper | N/A | N/A | N/A | A | A | A |
| magenta-yellow | A | B | C | A | B | D |
| magenta-black 1 | B | B | A | B | B | B |
| magenta-red | A | A | A | A | A | B |
| magenta-green | B | B | A | B | B | B |
| magenta-blue | B | B | B | B | B | B |
| magenta-colorless | A | A | C | N/A | N/A | N/A |
| magenta-plain | N/A | N/A | N/A | A | A | A |
| paper | | | | | | |
| Yellow-black 1 | A | B | D | B | B | D |
| Yellow-red | A | B | D | B | B | D |
| Yellow-green | B | B | C | B | C | D |
| Yellow-blue | B | C | D | B | C | D |
| Yellow-colorless | A | A | A | N/A | N/A | N/A |
| Yellow-plain paper | N/A | N/A | N/A | A | A | A |
| black-red | B | B | C | A | A | B |
| black 1-green | A | A | A | A | B | B |
| black 1-blue | A | A | A | A | A | A |
| black 1-colorless | A | A | C | N/A | N/A | N/A |
| black 1-plain paper | N/A | N/A | N/A | A | A | A |
| red-green | B | B | B | B | D | C |
| red-blue | B | C | D | B | D | D |
| red-colorless | A | A | C | N/A | N/A | N/A |
| protective | | | | | | |
| Red-plain paper | N/A | N/A | N/A | B | A | A |
| green-blue | A | A | A | A | B | C |
| green-colorless | A | A | C | N/A | N/A | N/A |
| green-plain paper | N/A | N/A | N/A | B | B | B |
| blue-colorless | A | A | D | N/A | N/A | N/A |
| protective | | | | | | |
| blue-plain paper | N/A | N/A | N/A | B | B | B |

Inspection of table 3 shows that only the inks of the invention provide acceptable performance for inter-color bleed on both microporous photoglossy and plain paper.

The invention has been described with reference to a preferred embodiment however it will be appreciated that variations and modifications can be effected by a person of ordinary skill in the art without departing from the scope of the invention.

1. A water based inkjet ink set comprising at least one cyan ink, at least one magenta ink, at least one yellow ink, at least one black ink, and at least one colorless protective ink, wherein:
(a) the cyan, magenta, yellow, and black inks each comprise a pigment colorant;
(b) the cyan, magenta, yellow, black, and colorless protective inks each comprise a polymeric binder additive; and
(c) the surface tensions of the inks have the following relationships:
(i) the dynamic surface tension at 10 milliseconds surface age for all inks of the ink set is greater than or equal to 35 mN/m,
(ii) the static surface tensions of the yellow ink and of the colorless protective ink are at least 2.0 mN/m lower than the static surface tensions of the cyan, magenta and black inks of the ink set, and
(iii) the static surface tension of the colorless protective ink is at least 1.0 mN/m lower than the static surface tension of the yellow ink.

2. A water based inkjet ink set according to claim 1 wherein the colorless protective ink comprises polymeric microgel particles.

3. A water based inkjet ink set according to claim 1 wherein the black ink comprises a mixture of carbon black pigment, cyan pigment and magenta pigment.

4. A water based inkjet ink set according to claim 1, comprising distinct first and second black inks, each comprising black pigments.

5. A water based inkjet ink set according to claim 4, wherein at least one of the black pigment inks is a self-dispersed carbon black pigment ink.

6. A water based inkjet ink set according to claim 1 wherein the polymeric binder additive is a polyurethane polymer.

7. A water based inkjet ink set according to claim 6 wherein the polyurethane polymer is a polycarbonate-type polyurethane.

8. A water based inkjet ink set according to claim 1 wherein at least one of the inks comprises an acrylic type polymeric additive.

9. A water based inkjet ink set according to claim 1 wherein at least one of the inks comprises a non-ionic acetylenic type surfactant.

10. A water based inkjet ink set according to claim 1 wherein at least one of the inks comprises an anionic phosphate ester type surfactant.

11. A water based inkjet ink set according to claim 1 wherein at least one of the inks of the ink set comprises a non-ionic secondary alcohol ethoxylate type surfactant.

12. A water based inkjet ink set according to claim 1 which further comprises a light cyan ink, light magenta ink, or light black ink.

13. A water based inkjet ink set according to claim 1 which further comprises a red ink or a blue ink.

14. A water based inkjet ink set according to claim 1 wherein at least one ink comprises a polyhydroxy alcohol compound.

15. An inkjet printing method comprising the steps of:
a) providing an inkjet printer that is responsive to digital data signals;
b) loading said printer with an inkjet recording element;
c) loading said printer with a water based inkjet ink set according to claim 1, and
d) printing a color image on said inkjet recording element using said inkjet ink set in response to said digital signals.

16. The inkjet printing method according to claim 15 wherein the printer comprises a thermal print head.
